(19) United States
(12) Patent Application Publication
(10) Pub. No.: US 2024/0385504 A1
(43) Pub. Date: Nov. 21, 2024

(54) IMAGE GENERATION UNIT AND PROJECTION DISPLAY APPARATUS

(71) Applicant: Panasonic Intellectual Property Management Co., Ltd., Osaka (JP)

(72) Inventor: Yuki YAMAGATA, Osaka (JP)

(21) Appl. No.: 18/788,719

(22) Filed: Jul. 30, 2024

Related U.S. Application Data
(63) Continuation of application No. PCT/JP2023/002460, filed on Jan. 26, 2023.

(30) Foreign Application Priority Data
Feb. 1, 2022 (JP) 2022-014072

(51) Int. Cl. G03B 33/12

(52) U.S. Cl. CPC G03B 33/12

(57) ABSTRACT

An image generation unit includes: three light modulation elements of a first light modulation element, a second light modulation element, and a third light modulation element, the three light modulation elements each modulating light based on an image signal to generate image light; a color separating and combining prism that guides the light to each of the three light modulation elements and includes a first prism, a second prism, and a third prism arranged in order from a light incident surface of the color separating and combining prism along an optical axis; a light-shielding plate that absorbs a part of OFF light generated by the third light modulation element, the OFF light having passed through the third prism, the second prism, and the first prism; and a reflecting surface that reflects the OFF light emitted from the first prism in a direction of the light-shielding plate.

### BACKGROUND

### 1. Technical Field

The present invention relates to an image generation unit and a projection display apparatus including the image generation unit.

### 2. Description of the Related Art

In recent years, projection display apparatuses (projectors) using digital micromirror devices (DMD) have been developed and are beginning to spread. In the digital micromirror device, in addition to on (ON) light that becomes image light optically modulated based on an image signal, off (OFF) light that does not appear in the image signal and is not used as the image light is generated. For this reason, it is necessary to direct the OFF light in a direction different from that of the image light, and for example, a technology in which the OFF light from the DMD is not incident on the color separating and combining prism is disclosed (See, for example, Patent Literature (PTL) 1).

PTL 1: Unexamined Japanese Patent Publication No. 2015-81931

### SUMMARY

However, when the DMD and the color separating and combining prism are

arranged so as not to allow the OFF light from the DMD to enter the color separating and combining prism as described above, it is necessary to separate the DMD and the color separating and combining prism at a certain interval, which causes a limitation such as an increase in the overall configuration of the projection display apparatus.

In addition, as will be described later, in a case where the OFF light from the DMD is incident on the color separating and combining prism, it is necessary to increase the height of the color separating and combining prism in order to release the OFF light to the upper side of the prism, and there is a limitation such as an increase in the overall configuration of the projection display apparatus.

Therefore, an object of the present disclosure is to provide an image generation unit including a DMD and a color separating and combining prism which can make a projection display apparatus compact.

An image generation unit according to the present disclosure includes: three light modulation elements of a first light modulation element, a second light modulation element, and a third light modulation element, the three light modulation elements each modulating light based on an image signal to generate image light; a color separating and combining prism that guides the light to each of the three light modulation elements and includes a first prism, a second prism, and a third prism arranged in order from a light incident surface of the color separating and combining prism along from a front side to a rear side of an optical axis; a light-shielding plate that absorbs a part of OFF light generated by the third light modulation element, the OFF light having passed through the third prism, the second prism, and the first prism; and a reflecting surface that reflects the OFF light emitted from the first prism in a direction of the light-shielding plate.

A projection display apparatus according to the present disclosure includes: a light source unit that generates light; a light guide optical system that guides the light from the light source unit; the image generation unit that modulates the light guided from the light guide optical system based on the image signal to generate the image light; and a projection optical system that projects the image light.

According to the image generation unit and a projection display apparatus using the image generation unit according to the present disclosure, the projection display apparatus can be made compact.

### BRIEF DESCRIPTION OF THE DRAWINGS

FIG. 1 is a block diagram illustrating a configuration of a projection display apparatus including an image generation unit according to a first exemplary embodiment.

FIG. 2 is a schematic diagram illustrating an optical system of a projection display apparatus including an image generation unit in FIG. 1.

FIG. 3 is a schematic perspective view illustrating a TIR prism and a color separating and combining prism in the projection display apparatus according to the first exemplary embodiment.

FIG. 4 is a schematic view of the TIR prism and the color separating and combining prism of FIG. 3 as viewed from the +Z direction.

FIG. 5 is a schematic view of the TIR prism and the color separating and combining prism of FIG. 3 as viewed from the −Y direction.

FIG. 6 is a schematic perspective view illustrating a TIR prism and a color separating and combining prism in a projection display apparatus according to a reference example.

FIG. 7 is a schematic view of the TIR prism and the color separating and combining prism of FIG. 6 as viewed from the +Z direction.

FIG. 8 is a schematic view of the TIR prism and the color separating and combining prism of FIG. 6 as viewed from the −Y direction.

### DETAILED DESCRIPTION

### Background to the Present Disclosure

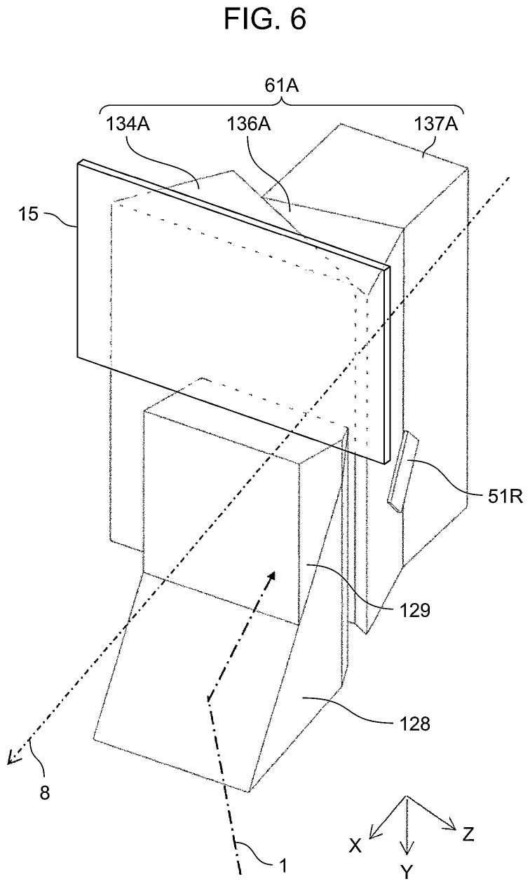

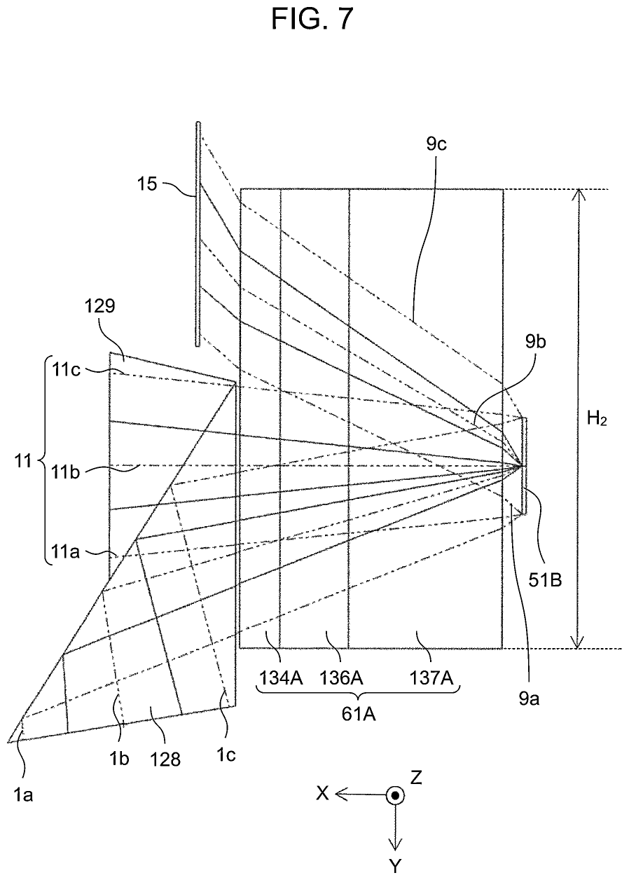

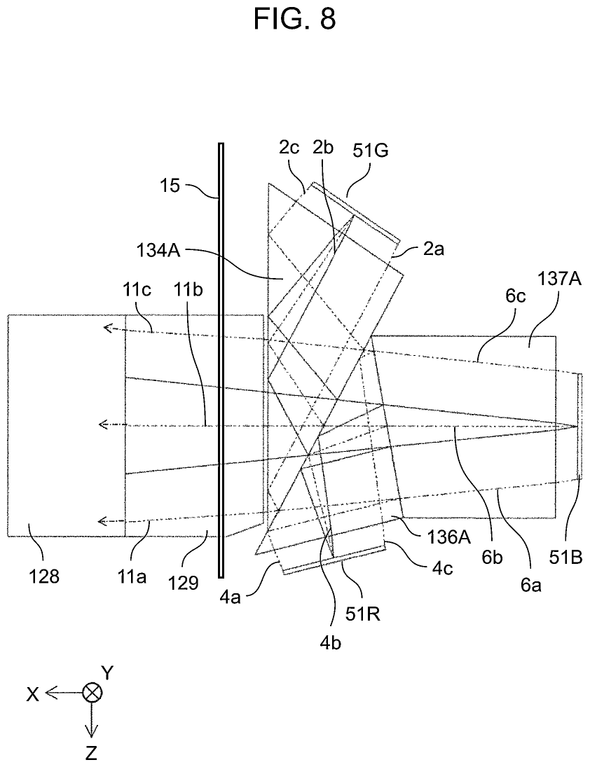

FIG. 6 is a schematic perspective view illustrating total internal reflection (TIR) prisms 128, 129 and color separating and combining prism 61A (First prism 134A, second prism 136A, third prism 137A) in the projection display apparatus according to the reference example. FIG. 7 is a schematic view of TIR prisms 128, 129 and color separating and combining prism 61A of FIG. 6 as viewed from the +Z direction. FIG. 8 is a schematic view of TIR prisms 128, 129 and color separating and combining prism 61A of FIG. 6 as viewed from the −Y direction.

In color separating and combining prism 61, for example, OFF lights 9a, 9b, 9c emitted from third DMD 51B which is the third light modulation element are directed in the −Y direction, that is, the height direction of triangular prism-shaped first prism 134A, second prism 136A, and third prism 137A as illustrated in FIG. 7, and are absorbed by light-shielding plate 15 provided on the optical axis side of first prism 134 A. Therefore, since OFF lights 9a, 9b, 9c pass through first prism 134A, second prism 136A, and third prism 137A, it is necessary to increase the overall height H₂ of color separating and combining prism 61A, and there is a problem that the overall configuration of the projection display apparatus becomes large.

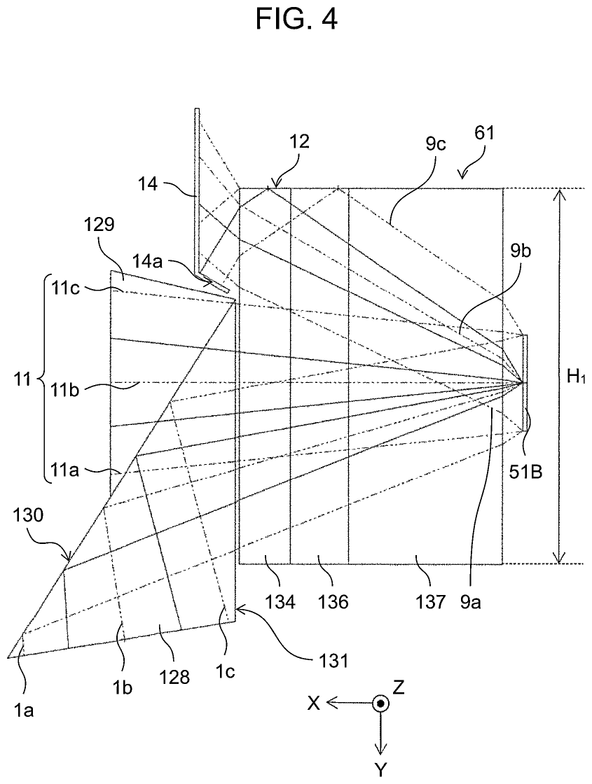

Therefore, as a result of intensive studies, the present inventor has found that height H₁ of color separating and combining prism 61 can be suppressed by providing reflecting surface 12 that reflects the OFF light to light-shielding plate 14 at least on the upper end surface of first prism 134, that is, the end surface in the direction opposite to the light guided from the light source to color separating and combining prism 61 as illustrated in FIG. 4, and has reached the present disclosure.

An image generation unit according to a first aspect includes: three light modulation elements of a first light modulation element, a second light modulation element, and a third light modulation element, the three light modulation elements each modulating light based on an image signal to generate image light; a color separating and combining prism that guides the light to each of the three light modulation elements and includes a first prism, a second prism, and a third prism arranged in order from a light incident surface of the color separating and combining prism along from a front side to a rear side of an optical axis; a light-shielding plate that absorbs a part of OFF light generated by the third light modulation element, the OFF light having passed through the third prism, the second prism, and the first prism; and a reflecting surface that reflects the OFF light emitted from the first prism in a direction of the light-shielding plate.

In an image generation unit according to a second aspect, in the first aspect, the reflecting surface may be provided on an end surface of the first prism in the direction opposite to the light guided from a light source to the color separating and combining prism, and the light-shielding plate may be provided on a front side of the first prism along the optical axis.

In an image generation unit according to a third aspect, in the second aspect, the light-shielding plate may have a bent portion bent toward the surface of the first prism to an end portion on a side of the optical axis.

In an image generation unit according to a fourth aspect, in the second or third aspect, the reflecting surface may extend from the end surface of the first prism to an end surface of the second prism.

In an image generation unit according to a fifth aspect, in any one of the second to fourth aspects, the reflecting surface may be configured as an upper surface of a glass plate attached to the end surface of the first prism.

In an image generation unit according to a sixth aspect, in any one of the second to fourth aspects, the reflecting surface may be configured as a surface of a transparent resin applied to the end surface of the first prism.

A projection display apparatus according to a seventh aspect includes: a light source unit that generates light; a light guide optical system that guides the light from the light source unit; the image generation unit according to any one of the first to sixth aspects that modulates the light guided from the light guide optical system based on the image signal to generate the image light; and a projection optical system that projects the image light.

An image generation unit according to an exemplary embodiment and a projection display apparatus including the image generation unit will be described below with reference to the accompanying drawings. In the drawings, substantially the same members are denoted by the same reference numerals.

### First Exemplary Embodiment

### <Projection Display Apparatus (Projector)>

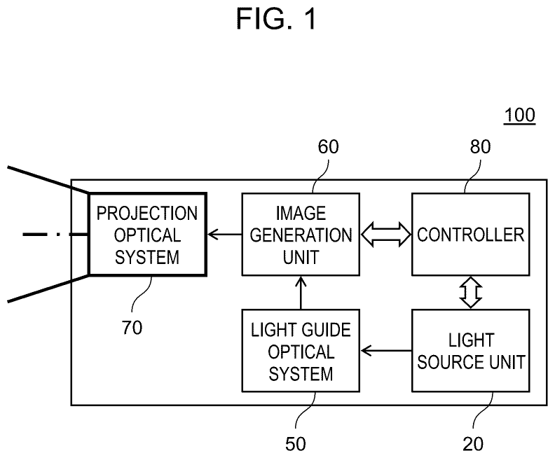

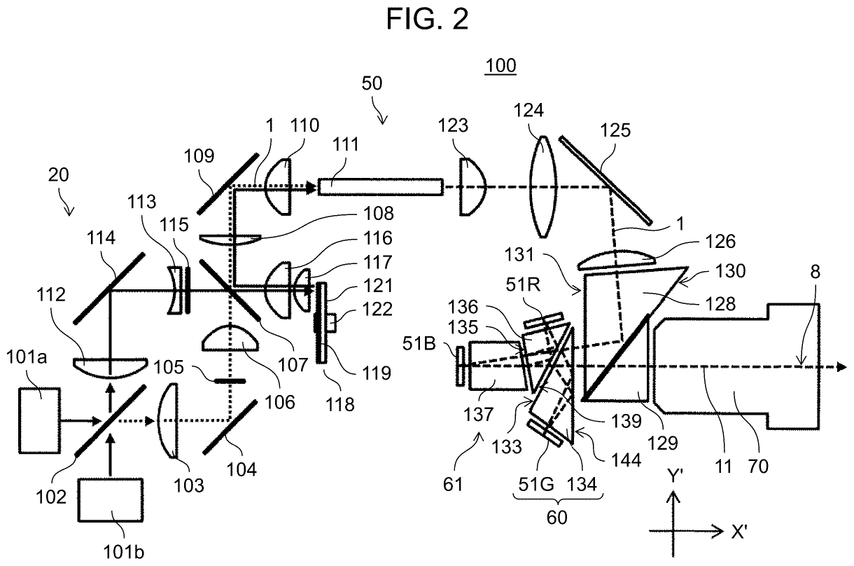

FIG. 1 is a block diagram illustrating a configuration of projection display apparatus (projector) 100 including an image generation unit according to a first exemplary embodiment. FIG. 2 is a schematic view illustrating an optical system of the projection display apparatus including the image generation unit in FIG. 1.

Projection display apparatus 100 according to the first exemplary embodiment includes light source unit 20, light guide optical system 50, image generation unit 60, projection optical system 70, and controller 80. Light guide optical system 50 is an optical system that guides light from light source unit 20 to image generation unit 60. The image generation unit 60 separates light into three primary colors of RGB by color separating and combining prism 61, and modulates each of the RGB light with an image signal by a digital micromirror device (DMD) to generate image light. Projection optical system 70 projects the generated image light onto a screen or the like to form an image. Controller 80 controls light source unit 20, light guide optical system 50, image generation unit 60, and projection optical system 70 described above.

Each member constituting projection display apparatus 100 will be described below.

### <Light Source Unit>

Light source unit 20 mainly includes first light source unit 101a, second light source unit 101b, separating and combining mirror 102, dichroic mirror 107, and phosphor wheel 118. Light source unit 20 further includes lens groups 103, 106, 112, 113, 116, 117, mirror groups 104, 114, and diffusion plate 105.

For example, first light source unit 101a and second light source unit 101b may be configured with a plurality of solid-state light sources such as a laser diode (LD) or a light emitting diode (LED). In the first exemplary embodiment, among laser diodes, a laser diode that emits blue light is particularly used as the solid-state light source. Here, the laser diode is an example of a laser light source.

The light emitted from first light source unit 101a and second light source unit 101b is, for example, blue light having a wavelength of between 440 nm and 470 nm (inclusive). This blue light is also used as excitation light for exciting phosphor 119 of phosphor wheel 118.

### <Phosphor Wheel>

Phosphor wheel 118 rotates about rotation axis 122 extending along the optical axis of the excitation light. Phosphor wheel 118 is a reflection-type phosphor wheel that emits fluorescence in a direction opposite to the incident direction of the excitation light. That is, phosphor wheel 118 includes substrate 121, phosphor 119 annularly applied and formed on substrate 121 along the rotation direction of substrate 121, and a motor (not illustrated) for rotating substrate 121 on which phosphor 119 is formed. A reflecting film for reflecting fluorescence emitted from phosphor 119 is formed on the surface of substrate 121. Phosphor 119 emits fluorescence including yellow light according to excitation light emitted from first light source unit 101a and second light source unit 101b.

The excitation light is diffused by top-hat diffusion element 115 and condensed on phosphor 119 by lenses 116, and 117 to emit fluorescence.

The phosphor is an example of a light emitter, and is, for example, a phosphor that emits fluorescence in a main wavelength range from green to yellow. Phosphor 119 is preferably a phosphor that efficiently absorbs blue excitation light to efficiently emit fluorescence and has high resistance to temperature quenching. Phosphor 119 is, for example, Y₃A₁₅O₁₂:Ce₃₊which is a phosphor having a garnet structure activated by cerium.

From light source unit 20, light (illumination light 1) including excitation light of blue light and fluorescence of yellow light is guided to light guide optical system 50.

### <Light Guide Optical System>

Light guide optical system 50 is an optical system that guides light (illumination light 1) from light source unit 20 to image generation unit 60. Light guide optical system 50 mainly includes rod integrator 111, lens groups 108, 110, 123, 124, 126, and mirror groups 109, 125.

Rod integrator 111 is, for example, a solid rod made of a transparent member such as glass. Rod integrator 111 can make spatial intensity distributions of excitation light emitted from first light source unit 101a and second light source unit 101b and fluorescence from phosphor wheel 118 uniform. Note that, rod integrator 111 may be a hollow rod whose inner wall is formed of a mirror surface. Rod integrator 111 is a type of light uniformizing element.

### <Image Generation Unit>

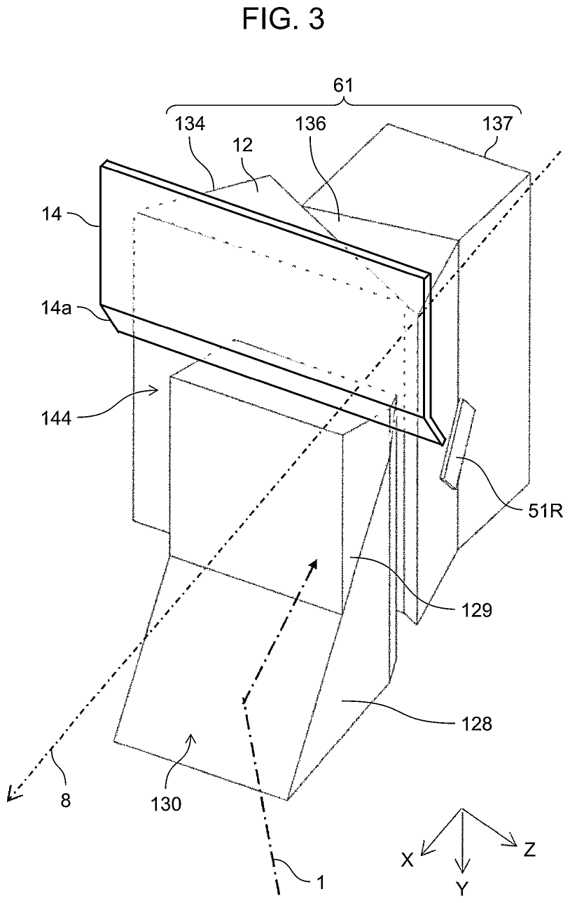

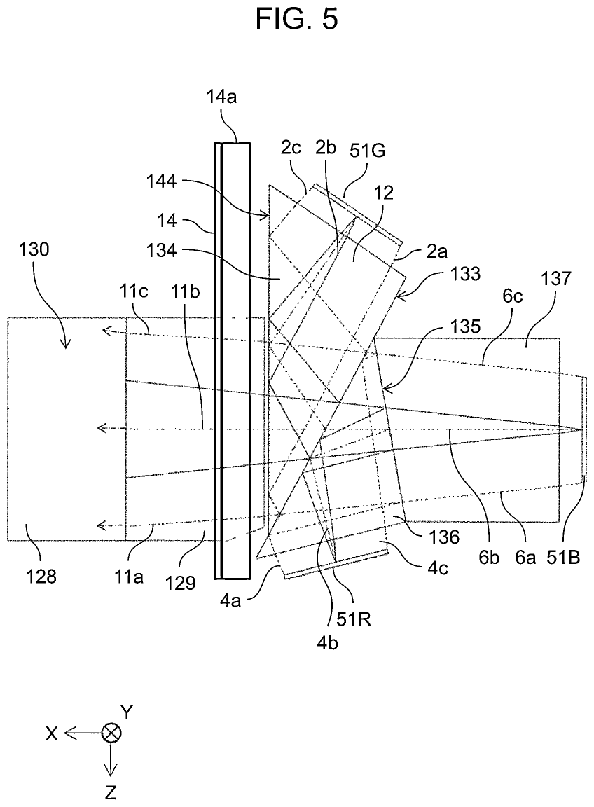

FIG. 3 is a schematic perspective view illustrating TIR prisms 128, 129 and color separating and combining prism 61 (first prism 134, second prism 136, and third prism 137) in projection display apparatus 100 according to the first exemplary embodiment. FIG. 4 is a schematic view of TIR prisms 128, 129 and color separating and combining prism 61 of FIG. 3 as viewed from the +Z direction. FIG. 5 is a schematic view of TIR prisms 128, 129 and color separating and combining prism 61 of FIG. 3 as viewed from the −Y direction.

For convenience, in FIG. 3, the direction of optical axis 8 of the image light generated by each light modulation element (DMD) is indicated as a +X direction. In each drawing, the height direction of each prism having a triangular prism shape of color separating and combining prism 61 is represented as the −Y direction. A Z direction perpendicular to the X direction and the Y direction is also shown.

Image generation unit 60 includes TIR prisms 128, 129 that guide illumination light 1 from light guide optical system 50 to color separating and combining prism 61, color separating and combining prism 61 including three prisms of first prisms 134, second prism 136, and third prism 137 that separate and combine illumination light 1 into three primary colors of RGB, and first DMD 51G, second DMD 51R, and third DMD 51B that are three digital micromirror devices (DMD) that generate image light by modulating based on image signals of the separated three primary colors of RGB.

Moreover, as illustrated in FIG. 4, image generation unit 60 includes reflecting surface 12 that reflects OFF lights 9a, 9b, 9c emitted from first prism 134 in a direction of light-shielding plate 14 on the end surface of first prism 134 in the −Y direction. In addition, light-shielding plate 14 that is provided on the front side of optical axis 8 of first prism 134 and absorbs a part of OFF light generated by the third modulation element (third DMD 51B), the OFF light having passed through third prism 137, second prism 136, and first prism 134 is provided.

### <TIR Prism>

TIR prisms 128, 129 guide illumination light 1 from light guide optical system 50 to color separating and combining prism 61. TIR prism 128 is formed of a light-transmissive member, and has surface 130 facing TIR prism 129 and surface 131 facing first prism 134 of color separating and combining prism 61. An air gap is provided between TIR prism 128 (FIG. 2: surface 130) and TIR prism 129, and the incident angle at which the light incident on TIR prism 128 is incident on surface 130 is larger than the critical angle, so that the light incident on TIR prism 128 is reflected by surface 130. On the other hand, an air gap is provided between TIR prism 128 (surface 131 in FIG. 2) and first prism 134 (surface 144 in FIG. 2), but the angle (incident angle) at which the light reflected by surface 130 is incident on surface 131 is smaller than the critical angle, so that the light reflected by surface 130 is transmitted through surface 131.

### <Light Modulation Element: Digital Micromirror Device (DMD)>

The first to third optical modulation elements (first DMD 51G, second DMD 51R, third DMD 51B) are, for example, digital micromirror devices (DMD). First DMD 51G, second DMD 51R, and third DMD 51B, which are digital micromirror devices, are configured by a plurality of movable micro mirrors, and each micro mirror corresponds to one pixel. In first DMD 51G, second DMD 51R, and third DMD 51B, by changing the angle of each micro mirror based on the image signal, whether or not light is reflected to the side of projection optical system 70 side is switched to generate image light. First DMD 51G, second DMD 51R, and third DMD 51B are one type of optical modulation elements.

Strictly speaking, the light guided to first DMD 51G is first component light (green component light) dispersed from illumination light 1 guided from light guide optical system 50, and the light modulated by first DMD 51G is first modulation light (green image light 2a, 2b, 2c). Similarly, the light guided to second DMD 51R is dispersed second component light (red component light), and the light modulated by second DMD 51R is second modulation light (red image light 4a, 4b, 4c). The light guided to third DMD 51B is dispersed third component light (blue component light), and the light modulated by third DMD 51B is third modulation light (blue image light 6a, 6b, 6c).

As illustrated in FIG. 4, first DMD 51G, second DMD 51R, and third DMD 51B respectively emit first modulation light (green image light 2a, 2b, 2c), second modulation light (red image light 4a, 4b, 4c), and third modulation light (blue image light 6a, 6b, 6c) that are ON (ON) light as image light, and emit OFF (OFF) light that does not become image light while deviating it from the optical axis (X direction). Note that green image light 2a, 2b, 2c, red image light 4a, 4b, 4c, and blue image light 6a, 6b, 6c respectively indicate image light emitted along widths of first DMD 51G, second DMD 51R, and third DMD 51B.

FIG. 4 illustrates only OFF light 9a, 9b, 9c from third DMD 51B which is the third modulation element. In FIG. 4, OFF lights emitted from other first DMD 51G and second DMD 51R are omitted. OFF light 9a, 9b, 9c indicates OFF light emitted along the width of third DMD 51B.

As illustrated in FIG. 4, OFF light 9a, 9b, 9c passes through third prism 137, second prism 136, and first prism 134, is partially reflected by reflecting surface 12, and is absorbed by light-shielding plate 14. For example, OFF light 9a, 9b passes through third prism 137, second prism 136, and first prism 134 and is absorbed by light-shielding plate 14, and OFF light 9c is reflected by reflecting surface 12 and is absorbed by bent portion 14a of light-shielding plate 14. As described above, the OFF light reflected by reflecting surface 12 is a portion on the side of OFF light 9c, but the range of the OFF light reflected by reflecting surface 12 changes depending on height H₁ of color separating and combining prism 61.

### <Color Separating and Combining Prism>

Color separating and combining prism 61 is formed of a light-transmissive member, and includes first prism 134, second prism 136, and third prism 137 arranged in order along the direction of optical axis 8. Color separating and combining prism 61 may be, for example, a dichroic prism-Phillips type. Surface 133 of first prism 134 is, for example, a dichroic mirror surface that transmits the red component light and the blue component light and reflects the green component light. Therefore, of illumination light 1 reflected by surface 130 of TIR prism 128, the red component light and the blue component light are transmitted through surface 133, and the green component light is reflected by surface 133. The green component light reflected by surface 133 is reflected by surface 144 and guided to first DMD 51G. Surface 135 of second prism 136 is a dichroic mirror surface that transmits the blue component light and reflects the red component light. Therefore, of the light incident on second prism 136, the blue component light is transmitted through surface 135, and the red component light is reflected by surface 135. The red component light reflected by surface 135 is reflected by surface 139 of second prism 136 and guided to second DMD 51R. The blue component light transmitted through surface 135 of second prism 136 and incident on third prism 137 is guided to third DMD 51B.

Note that the component light guided by the first prism and the third prism may be exchanged, the blue component light may be guided to the first DMD by the first prism, and the green component light may be guided to the third DMD by the third prism.

That is, the green component light, the red component light, and the blue component light are light dispersed by color separating and combining prism 61.

As illustrated in FIG. 5, first prism 134 receives green image light 2a, 2b, 2c that is the first modulation light modulated by first DMD 51G, and guides the green image light to the optical path along optical axis 8. Second prism 136 receives red image light 4a, 4b, 4c as the second modulation light modulated by second DMD 51R, and guides the received red image light to the optical path along optical axis 8. Third prism 137 receives blue image light 6a, 6b, 6c, which is the third modulation light modulated by third DMD 51B, and guides the blue image light to the optical path along optical axis 8.

That is, green image light 2a, 2b, 2c, red image light 4a, 4b, 4c, and blue image light 6a, 6b, 6c are combined in the same optical path along optical axis 8 by color separating and combining prism 61 to become image light 11 (11a, 11b, 11c).

### <Reflecting Surface>

As illustrated in a schematic diagram viewed from the +Z direction in FIG. 4, reflecting surface 12 is provided on at least an upper end surface of first prism 134, that is, an end surface in a direction (−Y direction) opposite to illumination light 1 (1a, 1b, 1c) guided from the light source to the color separating and combining prism. Reflecting surface 12 reflects the OFF light (particularly, the portion on the side of OFF light 9c) emitted from first prism 134 in a direction of light-shielding plate 14. Reflecting surface 12 may extend from the end surface of first prism 134 to the end surface of second prism 136. Furthermore, reflecting surface 12 may be provided over the end portions of first prism 134, second prism 136, and third prism 137.

By providing reflecting surface 12 on the upper end surface of first prism 134, height H₁ of color separating and combining prism 61 can be suppressed.

Reflecting surface 12 may be, for example, a polished surface formed by polishing the end surface of first prism 134 in the −Y direction. In addition, the reflecting surface may be configured as the upper surface of the glass plate adhered to the end surface of first prism 134 in the −Y direction. Alternatively, the reflecting surface may be formed as a surface of the transparent resin applied to the end surface of first prism 134 in the −Y direction. Note that the present invention is not limited to the above, and it is sufficient that the end surface of first prism 134 in the −Y direction can be a smooth surface that functions as a reflecting surface, that is, a sand shear surface serving as a diffusion surface, and that reflecting surface 12 can reflect OFF light toward light-shielding plate 14.

Note that height H₁ of color separating and combining prism 61 may be any height as long as OFF light 9a emitted from the end portion in the Y direction of third DMD 51B of the OFF light is not incident on TIR prism 129 and can pass through first prism 134.

### <Light-Shielding Plate>

As illustrated in FIG. 4, light-shielding plate 14 is provided on the front side of optical axis 8 of first prism 134. Light-shielding plate 14 may have bent portion 14a bent toward surface 144 of first prism 134 at the end portion on the side of optical axis 8. Light-shielding plate 14 absorbs a part of the OFF light generated by the third modulation element (third DMD 51B) and transmitted through third prism 137, second prism 136, and first prism 134. Further, it is possible to receive the OFF light reflected by reflecting surface 12 by bent portion 14a.

Note that, in a case where light-shielding plate 14 is provided close to the surface on the front side (X direction) of the optical axis of first prism 134, light-shielding plate 14 can sufficiently receive the OFF light reflected by reflecting surface 12, and thus, it is not necessary to provide bent portion 14a.

For example, light-shielding plate 14 may have a surface of metal such as aluminum painted black to make it difficult to reflect OFF light. Furthermore, light-shielding plate 14 may be excellent in heat dissipation, for example.

### <Projection Optical System>

Projection optical system 70 projects generated image light 11 onto a screen or the like to form an image.

### <Controller>

Controller 80 controls light source unit 20, light guide optical system 50, image generation unit 60, and projection optical system 70 described above.

Note that the present disclosure includes appropriate combination of arbitrary exemplary embodiments and/or examples among the various exemplary embodiments and/or examples described above, and effects of the respective exemplary embodiments and/or examples can be exhibited.

According to the image generation unit and the projection display apparatus of the present invention, height of color separating and combining prism can be suppressed and the projection display apparatus can be made compact.

What is claimed is:

1. An image generation unit comprising:
three light modulation elements of a first light modulation element, a second light modulation element, and a third light modulation element, the three light modulation elements each modulating light based on an image signal to generate image light;
a color separating and combining prism that guides the light to each of the three light modulation elements and includes a first prism, a second prism, and a third prism arranged in order from a light incident surface of the color separating and combining prism along from a front side to a rear side of an optical axis;
a light-shielding plate that absorbs a part of OFF light generated by the third light modulation element, the OFF light having passed through the third prism, the second prism, and the first prism; and
a reflecting surface that reflects the OFF light emitted from the first prism in a direction of the light-shielding plate.

2. The image generation unit according to claim 1, wherein
the reflecting surface is provided on an end surface of the first prism in a direction opposite to the light guided from a light source to the color separating and combining prism, and
the light-shielding plate is provided on a front side of the first prism along the optical axis.

3. The image generation unit according to claim 2, wherein the light-shielding plate has a bent portion bent toward a surface of the first prism at an end portion on a side of the optical axis.

4. The image generation unit according to claim 2, wherein the reflecting surface extends from the end surface of the first prism to an end surface of the second prism.

5. The image generation unit according to claim 2, wherein the reflecting surface is configured as an upper surface of a glass plate attached to the end surface of the first prism.

6. The image generation unit according to claim 2, wherein the reflecting surface is configured as a surface of a transparent resin applied to the end surface of the first prism.

7. A projection display apparatus comprising:
a light source unit that generates light;
a light guide optical system that guides the light from the light source unit;
the image generation unit according to claim 1 that modulates the light guided from the light guide optical system based on the image signal to generate the image light; and
a projection optical system that projects the image light.
